(19) United States
(12) Patent Application Publication
(10) Pub. No.: US 2008/0131124 A1
(43) Pub. Date: Jun. 5, 2008

(54) METHOD AND APPARATUS FOR PARTIAL DUPLEX PROTECTION SWITCHING BY USING SINGLE SPLITTER IN PON

(75) Inventors: Hong Soon NAM, Daejeon-City (KR); Dong Beom SHIN, Daejeon-City (KR); Sang Yeoun LEE, Daejeon-City (KR); Kwang Soo CHO, Daejeon-City (KR); Hyun Jeong YUN, Daejeon-City (KR); Heyung Sub LEE, Daejeon-City (KR); Yool KWON, Busan-City (KR); Bong Tae KIM, Busan-City (KR)

Correspondence Address: RABIN & Berdo, PC, 1101 14TH STREET, NW, SUITE 500, WASHINGTON, DC, 20005, US

(73) Assignee: Electronics and Telecommunications Research Institute, Daejeon-City (KR)

(21) Appl. No.: 11/948,933

(22) Filed: Nov. 30, 2007

(30) Foreign Application Priority Data
Dec. 5, 2006 (KR) 10-2006-0122566

(51) Int. Cl. H04J 14/00

(52) U.S. Cl. 398/67

(57) ABSTRACT

A method and apparatus for duplex protection switching by using a single splitter in a passive optical network (PON) are provided. The apparatus for duplex protection switching in a PON, in which a single optical line termination (OLT) and many optical network terminations (ONTs) are connected together in a multiple-access manner, includes: a 2:2 splitter connected to two PON line terminations (LTs) in the OLT; and two N:1 splitters which are connected to the 2:2 splitter, and each of which is connected to two PON LTs in the ONT. According to the method and apparatus, an economical effect can be provided in which two links, an operational link and a protection link, in the PON can provide a partial duplex function at a lower cost. Also, a protection switching time can be reduced by simplifying a restoration process so that when an error is detected, an operational state is returned by protection switching.

### CROSS-REFERENCE TO RELATED PATENT APPLICATIONS

This application claims the benefit of Korean Patent Application No. 10-2006-0122566, filed on Dec. 5, 2006, in the Korean Intellectual Property Office, the disclosure of which is incorporated herein in its entirety by reference.

### BACKGROUND OF THE INVENTION

1. Field of the Invention

The present invention relates to a method and apparatus for partial duplex protection switching in a gigabit-passive optical network (G-PON), and more particularly, to a method and apparatus for G-PON partial duplex protection switching by which one 2:2 splitter and two N:1 splitters are used to provided only two links, an operational link and a protection link, between two splitters, thereby providing an economical protection switching network and a protection switching process is simplified to support fast switching.

This work was supported by the IT R&D program of MIC/IITA [2005-S-401-02, Optical Subscriber and Access Network Technology]

2. Description of the Related Art

A passive optical network (PON) operates with an optical line termination (OLT) disposed on a network side, and many optical network terminations (ONTs) disposed on a subscribers' side. The OLT is connected to the ONTs and an optical distribution network (ODN). In order to connect one OLT and many ONTs the ODN is formed with splitters, which are passive optical couplers, and optical links. If an error occurs, the PON is required to automatically restore a normal operation and continuously provide services so that the PON can provide high-quality real-time services as well as accommodate many subscribers.

In order to provide continuous services when an error occurs, the PON has a protection link. If an error occurs in an operational link, first, the service is switched to a protection link and the cause of the error is identified and then, normal operation is restored. In order to provide continuous services in this way even if an error occurs, the protection switching requires detection of an error and switching to a protection link based on the detected error information, and should reduce the time required for restoring a normal service state when the service is switched to the protection link.

Conventional protection switching methods include PON full duplex structure switching and PON partial duplex switching. In the PON full duplex structure, two PON links are disposed, and one operates as an operational link and the other operates as a protection link. Accordingly, if an error occurs in a part of the operational link, the service is switched to the protection link, thereby allowing the service to be continuously provided. This method requires the operation of two independent PON links, and thus requires an expensive structure. Also, a duplication operation in the method is complicated.

In the partial duplex structure, which is described in ‘Duplex System Configuration in Passive Double Star System’ (GLOBECOM '94, pp. 1930-1934), two 2:1 splitters and two N:2 splitters are disposed between two OLT PON line terminals (LTs) and two ONT PON LTs. If data is transmitted by one PON LT, the data is transferred to a reception side through two paths through splitters. The reception side selects a better path and receives the data.

This method has an advantage that even when an ONT with a duplication function is matched with an ONT without a duplication function, and when the link between an ONT and a splitter is not duplicated, the link for the interval between the OLT PON LT and the splitter can be duplicated. However, the method requires four links to connect the two 2:2 splitters and the two N:2 splitters, and thus there is a high construction cost. Also, when an error occurs in the link for this interval, the ONT and OLT can be switched at the same time, thereby complicating the protection switching.

In the PON, since many ONTs access one OLT in a time division multiple access (TDMA) method, ranging is performed so that data transmitted by each ONT can be received by the OLT at a predetermined period of time when the OLT receives the data.

The ranging can be performed by measuring a round trip delay (RTD) between the OLT and the ONT. Since data cannot be transmitted during the ranging state, the ranging should be performed as fast as possible for faster restoration if protection switching is performed. Methods of fast ranging include fast protection switching by snooping on downstream signals in an optical network (U.S. Pat. No. 6,771,908, Aug. 3, 2004) and fast protection switching by snooping on upstream signals in an optical network (U.S. Pat. No. 6,868,232, Mar. 15, 2005).

According to these methods, the RTDs of an operational link and a protection link are measured at a normal state, and the ranging delay difference, that is, the difference between the times, is managed. Then, when protection switching is performed, the ranging delay difference, i.e., the difference between the delays, is utilized, thereby omitting or accelerating the ranging process with respect to changes in the distance between an OLT and ONT. In this way, the methods provide an advantage in that a protection switching time is reduced. Even in this case, many links (one operational link and three protection links) are required between a 2:1 splitter and N:2 splitters, and if an error occurs in the link between two splitters, the OLT and the ONT detect the error at the same time and thus, both the ONT and OLT may be switched. Accordingly, the duplication switching process is complicated.

In addition, since many possible switching paths exist when both the ONT and the OLT is switched, the ranging delay difference which is managed may be much different from an actual path. Also, in a G-PON, if an error state continues for a predetermined period of time in an operational state, the operational state is transited to a standby state, and in order to transit from the standby state to an operational state, additional time is required. Accordingly, a method of immediately determining how protection switching is performed from a result of detecting an error so that restoration is performed in the operational state is necessary.

### SUMMARY OF THE INVENTION

The present invention provides a method and apparatus by which one 2:2 splitter and two N:1 splitters are used to provide only two links, an operational link and a protection link, between two splitters, thereby providing an economical protection switching network and a protection switching process is simplified to support fast switching.

The present invention also provides a method and apparatus for restoring a normal state after switching, by reducing the time required for determining from error information how protection switching is performed for fast protection switching, and determining the time required for a protection link to provide a normal service after switching is performed.

The present invention also provides an apparatus and method for passive optical network (PON) link protection switching, using an effective and economical single splitter. According to the apparatus and method, in order to reduce a protection switching time, and in order to reduce a process in which if a signal detection failure (SDF) in a physical layer is detected or a loss of signal (LOS) or a loss of frame (LOF) in a PON link layer is detected, protection switching is requested and if an error in a predetermined optical network termination (ONT) of an optical line termination (OLT) continues, protection switching of the ONT is requested, a process in which when protection switching is requested, a protection link state is confirmed and protection switching is performed, and a time required for restoration to a normal state after protection switching is performed, an operational link and a protection link are disposed such that even when an OLT is switched, the distance between the operational link and the protection link does not change, thereby omitting or accelerating a ranging process. Also, when the ONT is switched, only the ONT is ranged.

The present invention also provides a computer readable recording medium having embodied thereon a computer program for executing the methods.

According to an aspect of the present invention, there is provided an apparatus for duplex protection switching in a passive optical network (PON), in which a single optical line termination (OLT) and a plurality of optical network terminations (ONTs) are connected together in a multiple-access manner, including: a 2:2 splitter connected to two PON line terminations (LTs) in the OLT; and two N:1 splitters which are connected to the 2:2 splitter, and each of which is connected to two PON LTs in the ONT.

Each of the PON LTs in the OLT may be connected to the 2:2 splitter with a link having the same length.

The two N:1 splitters may be connected to the 2:2 splitters through links of different paths, respectively.

In the OLT, the two PON LTs in the OLT may be connected to a first link and a second link, respectively, which transmit and receive data between the OLT and the ONTs, and the OLT may have a switch for transmitting data to and receiving data from one of the first link and the second link.

The ONT may include: a PON LT including an optical transmission and reception unit converting an electrical signal into an optical signal or an optical signal into an electrical signal, and transmitting and received an optical signal between the ONT and the N:1 splitter; a PON connection unit transmitting and receiving data between the optical transmission and reception unit and a subscriber of the PON; and a switch connecting the optical transmission and reception unit and the PON connection unit.

When the first link for transmitting and receiving data in the two links connecting the ONT and the N:1 splitter becomes a state of signal loss or frame loss, and thus data is transmitted and received through the second link, the ONT may be connected to the N:1 splitter through a ranging process with respect to the length of the second link.

According to another aspect of the present invention, there is provided a method of managing two links of a PON in which a single OLT and a plurality of ONTs are connected together in a multiple-access manner, the method including: measuring a round trip delay time between the OLT and the ONT, and ranging the distance in which the ONT transmits data to and receives data from the OLT; if a first link through which data is transmitted and received between the ONT and the OLT becomes a state of signal loss or frame loss, stopping transmission and reception of data in the first link, and performing a popup test of the OLT; and if the OLT receives the popup test result message, transmitting and receiving data through a second link connected between the OLT and the ONT.

In the stopping of the transmission and reception of data in the first link, and the performing of the popup test of the OLT, if an optical signal detection is failed through the first link may be stopped and the popup test of the OLT is performed.

In the transmitting and receiving of data through the second link connected between the OLT and the ONT, if the popup test result message is not received within a predetermined time, the transmission and reception of data between the ONT and the OLT may be stopped.

According to another aspect of the present invention, there is provided a method of managing two links of a PON in which a single OLT and a plurality of ONTs are connected together in a multiple-access manner, the method including: the OLT searching for the ONT matched with the link of the OLT; measuring a round trip delay time between the found ONT and the OLT, and ranging the distance in which the ONT transmits data to and receives data from the found ONT; if a first link through which data is transmitted and received between the ONT and the OLT becomes a state of signal loss or frame loss, stopping transmission and reception of data in the first link, and performing a popup test of the OLT; and if the OLT transmits the popup test result message to the ONT, transmitting and receiving data through a second link connected between the OLT and the ONT.

In the stopping of the transmission and reception of data in the first link, and the performing of the popup test of the OLT, if an optical signal detection is failed through the first link, the transmission and reception of data in the first link may be stopped and the popup test of the OLT is performed.

In the transmitting and receiving of data through the second link connected between the OLT and the ONT, if the OLT transmits the popup test result to the ONT, the ONT may transmit and receive data through the second link connected between the OLT and the ONT.

According to another aspect of the present invention, there is provided method of managing two links of a PON in which a single OLT and a plurality of ONTs are connected together in a multiple-access manner, the method including: setting one of the two links of a PON as a first link for transmitting and receiving data; unless the first link is a state of signal loss or frame loss, transmitting and receiving data between the OLT and the ONT through the first link; and if the first link is a state of signal loss or frame loss, setting the other link of the two links of a PON as a second link for transmitting and receiving data.

### BRIEF DESCRIPTION OF THE DRAWINGS

The above and other features and advantages of the present invention will become more apparent by describing in detail exemplary embodiments thereof with reference to the attached drawings in which:

FIG. 1 is a schematic diagram of a partial duplex structure as an example of a conventional passive optical network (PON) link duplication structure;

FIG. 2 is a schematic diagram of a structure of an apparatus for partial duplex protection switching in a PON according to an embodiment of the present invention;

FIG. 3 is a schematic diagram for explaining a protection switching path for when a link error occurs, according to an embodiment of the present invention;

FIG. 4 is a state transition diagram of a gigabit-passive optical network (G-PON) according to the state of an error according to an embodiment of the present invention;

FIG. 5 is a state transition diagram of a G-PON optical line termination (OLT) according to the state of an error according to an embodiment of the present invention;

FIG. 6 is a flowchart illustrating a process of selecting an operational link according to an embodiment of the present invention;

FIGS. 7A, 7B, and 7C are schematic diagrams for explaining a process of replacing a defective splitter according to an embodiment of the present invention; and

FIG. 8 is a simplified schematic diagram for explaining an apparatus for partial duplex protection switching in a PON according to an embodiment of the present invention.

### DETAILED DESCRIPTION OF THE INVENTION

The present invention will now be described more fully with reference to the accompanying drawings, in which exemplary embodiments of the invention are shown.

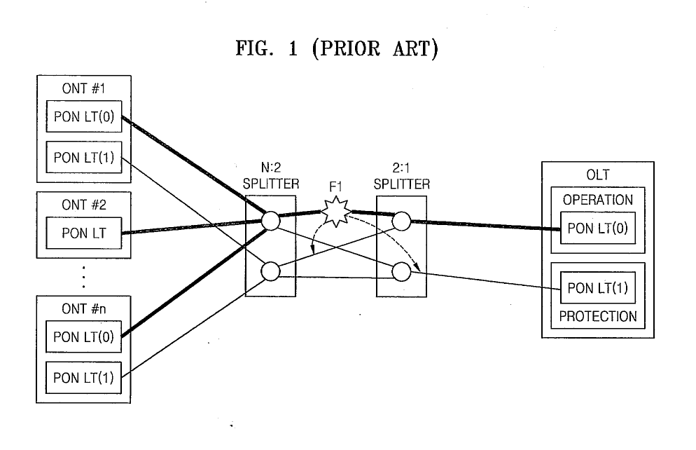

FIG. 1 is a schematic diagram of a partial duplex structure as an example of a conventional passive optical network (PON) link duplication structure.

The conventional partial duplex structure is formed of two optical line termination (OLT) PON line terminals (LTs), two 2:1 splitters, two N:2 splitters, and two optical network termination (ONTs) PON LTs, as illustrated in FIG. 1. In one PON, ONTs with a duplication function, such as ONT1 and ONT3, and an ONT without the duplication function, such as ONT2, operate at the same time. The ONT with the duplication function provides duplication of a link from the OLT to the ONT. For a subscriber for whom the duplication function is not provided or a link for an interval between the N:1 splitter and the ONT is not duplicated, the OLT provides the duplication function for the N:1 splitter interval.

For transmission of data between the OLT and an ONT in this structure, if one operational PON LT transmits data, a reception side can receive the data through two different paths through an optical distribution network (ODN). The reception side can select an optimal path from among the two paths and receive the data.

Even if an error occurs in a predetermined ONT and the ONT is switched off, another ONT is not switched off and the operating state can be maintained.

This structure requires four links in order to connect the 2:1 splitter and the N:2 splitters. During operation, one link from among the four links is an operational link and the other three are protection links. Having three protection links is not economical and in addition, when protection switching is performed due to an error in the operational link, switching in the ONT and switching in the OLT may occur, thereby complicating the protection switching.

For example, if it is assumed that a link error occurs in F1 as illustrated in FIG. 1, both the ONT and OLT detect the error in the operational link. Since protection links of the ONT and OLT are normal, each of the ONT and OLT may be protection-switched. If protection switching is performed both in the OLT and ONT, the OLT PON LT and the 2:1 splitter are switched to the protection link, and thus ranging of the whole PON is required. Accordingly, it may take a long time to restore an operational state.

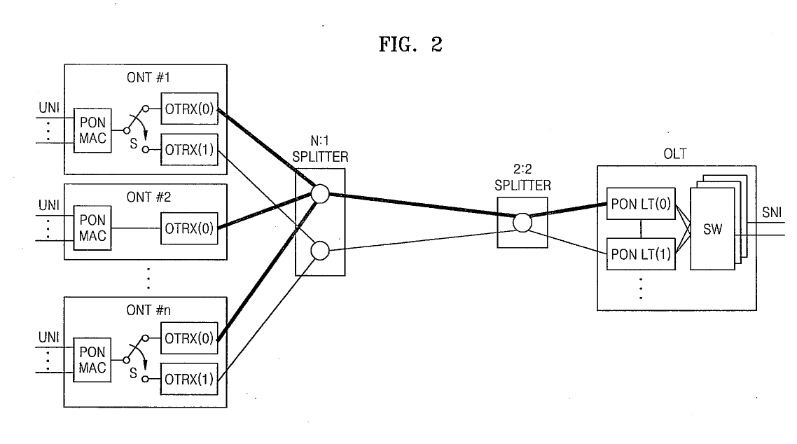

FIG. 2 is a schematic diagram of a structure of an apparatus for partial duplex protection switching in a PON according to an embodiment of the present invention.

As illustrated in FIG. 2, a G-PON is formed of ONTs disposed on the side of a user network interface (UNI) which is an interface for a user network, an OLT disposed on the side of a service node interface (SNI), and a passive optical link connecting the ONTs and OLT.

An ONT matches and multiplexes a plurality of subscribers. Then, by performing a G-PON MAC matching process, the ONT is matched with a G-PON link through an optical transceiver (OTRX). The G-PON MAC converts Ethernet or time division multiplexing (TDM) data received from a subscriber into a frame that can be accommodated by the G-PON, multiplexes the converted data, and then, transfers the data to the OTRX. In a reverse process, the G-PON MAC removes a G-PON frame from data received from the OTRX, demultiplexes the data and, then, transfers the data to a corresponding subscriber.

Also, the G-PON MAC manages the states of the G-PON, such as ONT ID. If a valid signal from the OTRX is not received for a predetermined period of time, the G-PON MAC reports a loss of signal (LOS). If a valid frame is not received for a predetermined period of time, the G-PON MAC reports a loss of frame (LOF). In this way, the G-PON MAC performs an operational administration and management (OAM) function required for the G-PON. The OTRX converts an electrical signal received from a PON MAC into an optical signal, and transfers the optical signal to a PON link. In a reverse process, the OTRX converts an optical signal received from a PON link into an electrical signal and transfers the electrical signal to a PON MAC. Also, the OTRX monitors an optical signal and determines signal detection (SD) or a signal detection failure (SDF).

The ONTs include duplicated ONTs, such as ONT 1 and ONT 3, and ONTs without duplication, such as ONT 2. FIG. 2 illustrates an example of a PON link duplication structure of an interval between an OLT and ONTs in which the OTRX is duplicated as Work_OTRX expressed by thick solid lines and Prot_OTRX expressed by thin solid lines, in order to duplicate only the optical link.

The OLT is matched with a plurality of PON links and the plurality of links exchange data with the SNI by using a switch (SW). The SW is for reliably exchanging data of a PON LT accommodated by the OLT. In general, the SW is formed using a duplicated structure. For duplication, the PON link of the OLT is formed using an operational PON LT expressed by thick solid lines and a protection PON LT expressed by thin solid lines. The protection PON LT shares PON information, such as ONT IDs, and round trip delays (RTDs), with the operational PON LT, and utilizes the information when OLT protection switching is performed.

An optical link is formed with two OLT PON LTs, one 2:2 splitter, two N:2 splitters, two ONT LTs, and all links between the OLT and ONTs are duplicated. The link expressed by thick solid line indicates an operational link, and the link expressed by thin solid line indicates a protection link. In the optical link, in order to reduce change in the distance between the operational link and the protection link, the 2:2 splitter is disposed close to the OLT PON LTs so that the lengths of the two links are maintained to be almost the same.

Accordingly, when a link is switched in this interval, the distances of the two links are identical, and a ranging process can be omitted. Meanwhile, the interval between the 2:2 splitter and the N:1 splitter is a main protection interval, and generally, links of this interval are arranged to have different paths, so that errors do not occur at the same time if possible. The lengths of two links between the N:1 splitter and the ONT are generally similar, and when a difference between the distances exists, a ranging process is required for only the ONT.

In an embodiment of the present invention, the four links connecting the 2:2 splitter and the N:2 splitter in the conventional technology are reduced to two links and a partial duplication structure is provided. A transmission side of the OLT and ONTs transmits a signal from only one PON LT, and this signal is transferred through an operational link and a protection link by using the splitters. The reception side can receive the signal through two paths, and select an optimal one from among the two paths. According to an embodiment of the present invention, if an error occurs in an arbitrary interval of an operational link, the connection is switched to a protection link of the interval, thereby minimizing change in the topology of the PON when switching is performed.

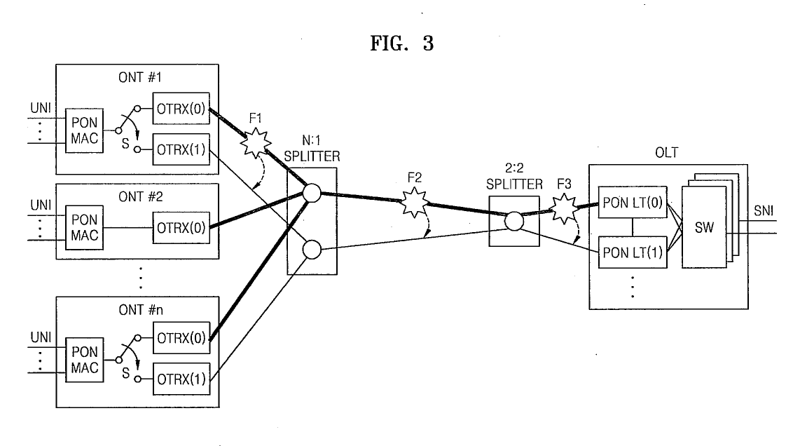

FIG. 3 is a schematic diagram for explaining a protection switching path for when a link error occurs, according to an embodiment of the present invention.

Referring to FIG. 3, thick solid lines indicate an operational link, thin solid lines indicate a protection link, and F1 through F3 indicate positions of errors. If errors occur at F1 through F3, the connection is switched to a protection link corresponding to the interval as indicated by arrows expressed by dotted lines. If an error occurs in an interval between the ONT and N:1 splitter at F1, the ONT corresponding to the interval detects the error of the operational link, and is protection-switched, thereby minimizing the effect of the error on the other ONTs and the OLT. If an error occurs in an interval between the N:1 splitter and the 2:2 splitter at F2, the OLT as well as the ONT detects an error in the operational link.

In this case, the state of the protection link of the ONT is maintained at a normal state, but the sate of the protection link of the ONT is transited to an error state. Accordingly, the ONT can be protection-switched, but the OLT is not protection-switched. If an error occurs in an interval between the OLT PON LT and the 2:2 splitter at F3, the ONT and the OLT each detect an error, but the protection link of the OLT is in a normal state and the protection link of the ONT is in an error state. Accordingly, only the OLT is protection-switched. If the distance of the operational link and the distance of the protection link of this interval are maintained to be the same, even if protection switching is performed, there is almost no change in the ranging, and therefore the protection switching can be easily performed.

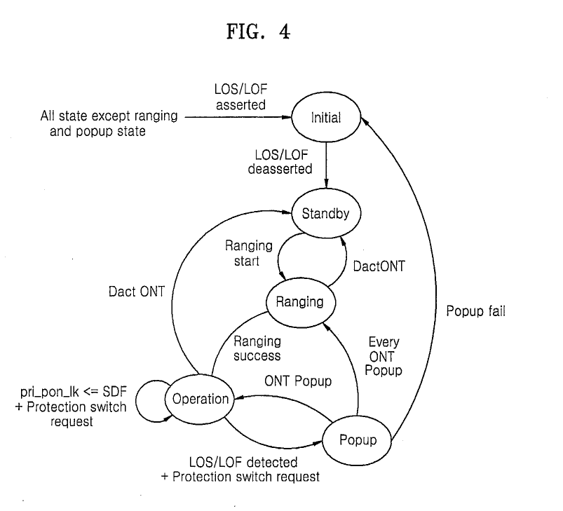

FIG. 4 is a state transition diagram of a G-PON according to the state of an error according to an embodiment of the present invention.

If power is turned on in an ONT, the ONT enters into an initial state. In the initial state, LOS and LOF are released, and if the state of a link becomes normal, the ONT enters into a standby state. In this state, the ONT performs a series of processes for communicating data with an OLT, including adjusting the magnitude of power for optical transmission, and registering its ID. After the ONT ID is registered, the OLT performs ranging in order to accurately receive data transmitted by each ONT.

In the ranging, the RTD time between the OLT and the ONT is measured and used to adjust the time required for the ONT to transmit data to the OLT. If the ranging is successful, the ONT enters into an operational state. However, if the ranging fails, or if a DACT ONT message from the OLT is received, the ONT again enters into a standby state. In the operational state, the ONT transmits data to or receives data from the OLT. In this state, if the optical reception state of the operational link is lowered to an SDF state, the ONT requests protection switching and maintains the operational state. In the operational state, if an LOS or LOF occurs, the ONT requests duplication switching and the state of the ONT is transited to a popup state. In the popup state, transmission of data is stopped and the ONT waits for a popup test of the OLT.

If a message from the OLT, which requests the ONT or all ONTs to enter into a popup state according to the result of the popup test is received, the state of the ONT is transited again to the operational state or to a ranging stage. If the popup message is not received for a predetermined time, it is regarded that the popup test has failed, and the state is transited to an initial state. In this case, during the transition time from the initial state to an operational state, the service is stopped. In the present embodiment, processes for requesting switching due to detection of an SDF and requesting protection switching for transition from an operational state to a popup state are added to the conventional G-PON link state transition diagram.

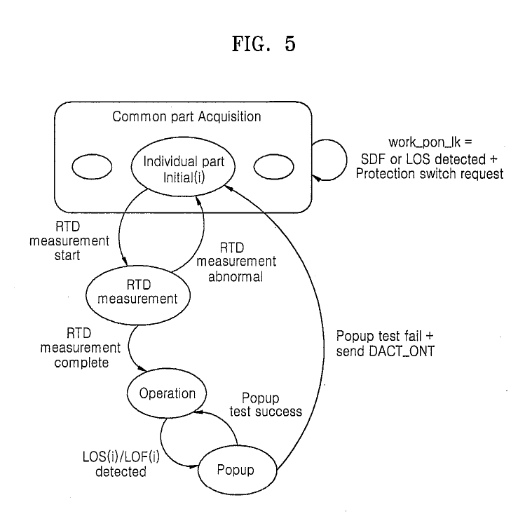

FIG. 5 is a state transition diagram of a G-PON OLT according to the state of an error according to an embodiment of the present invention.

The states of the OLT include the states of a common part and an individual part managing a PON link. If initial power is applied to the common part, the common part periodically performs an acquisition process for finding an ONT matched with the PON link of the common part. If a new ONT is found, the common part allocates an ONT ID to the ONT and requests the individual part to measure the RTD. In the initial state, if the RTD measurement is requested by the common part, the individual part enters into an RTD measurement state, and in the RTD measurement state, the RTD is measured and the result of the measurement is transferred to the common part.

If the RTD measurement is finished, the state of the individual part is transited to an operational state, and if the RTD measurement fails, the state is transited to an initial state. In the operational state, data is transmitted to or received from the corresponding ONT. If an LOS or LOF is detected in the operational state, the state is transited to a popup state. In the popup state, transmission of data is stopped and a popup test is performed. In the popup test, a popup message is transmitted to the ONT and if a response message to the transmitted message is received, the popup test is finished and the state is transited to an operational state. However, if the response message is not received, it is regarded that the popup test has failed, and a DACT_ONT message and an ONT protection switching (Protection ONU) message are transmitted to the corresponding ONT and the state is transited to an initial state.

An ONT protection switching request is made when data is received by the OLT and signals from other ONTs are received, and the signal from a predetermined ONT is not received. In this case, since an error may exist in the transmission function of the predetermined ONT, protection switching is requested. At this time, if an error exists in both direction signals, this message is not transmitted to the corresponding ONT, and therefore, the ONT is not protection-switched. Since the OLT is matched with a plurality of ONTs, if an error is detected in an individual ONT, the OLT is not protection-switched. However, if an LOS or LOF is detected in all the ONTs, or if an SDF is detected due to a lowered optical signal of a PON LT, protection switching of the PON LT is requested. In the present embodiment, processes for requesting protection switching due to detection of an error and requesting ONT protection switching are added to the conventional G-PON link state transition diagram.

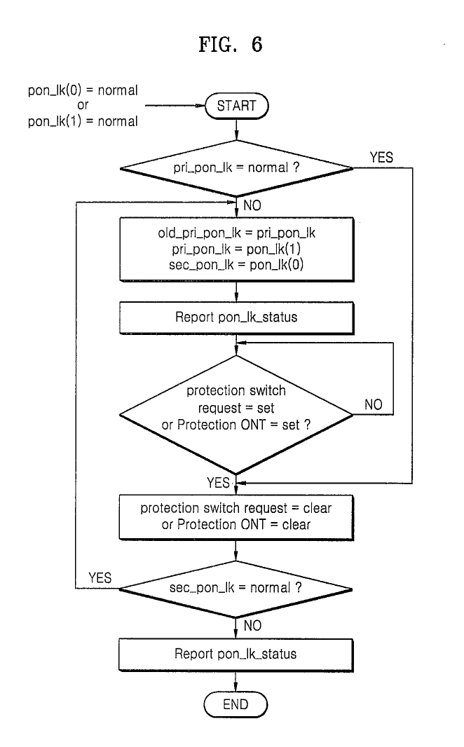

FIG. 6 is a flowchart illustrating a process of selecting an operational link according to an embodiment of the present invention.

If power is supplied to an initial PON link, or if a protection switching request is received as illustrated in FIGS. 4 and 5, a process for selecting an operational link (pri_pon_lk) as illustrated in FIG. 6 is performed. In an initial state, an arbitrary link is set as an operational link and another link is set as a protection link (sec_pon_lk)

If any one of the two links is released from an LOS or LOF and enters into a normal state, it is determined whether or not an operational state is normal. If the operational state is normal, the state is maintained. Otherwise, a normal link is selected as an operational link. If the operational link is selected, the other link becomes a protection link. If the operational link is selected, the link state is reported and until a protection switching request is made, the operational state is maintained.

Protection switching requests include a protection switching request from a result of detecting an error in an OLT or ONT itself, and a protection switching request due to reception of a predetermined ONT protection switching (protection ONT) message.

If an error of an operational link is detected, or a protection switching request is received, the state of the protection link is determined. If the result of the determination indicates that the state of the protection link is normal, the connection is switched to the protection link, or else, the process is finished. In the case when the process is finished, the operational link is maintained so that repetition of protection switching can be prevented.

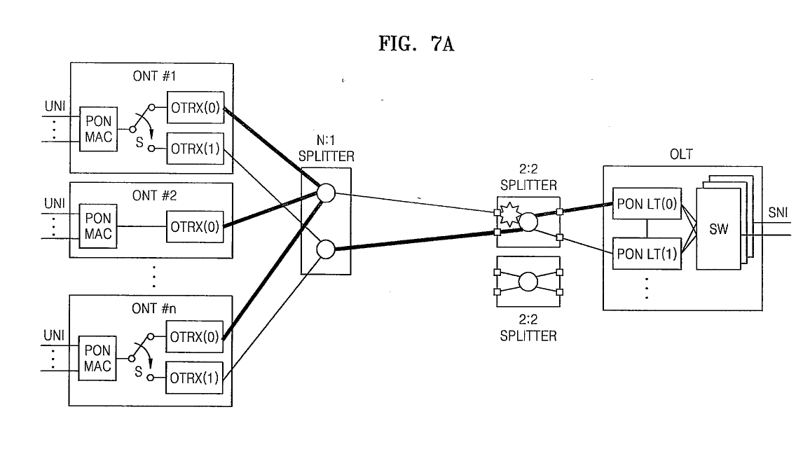

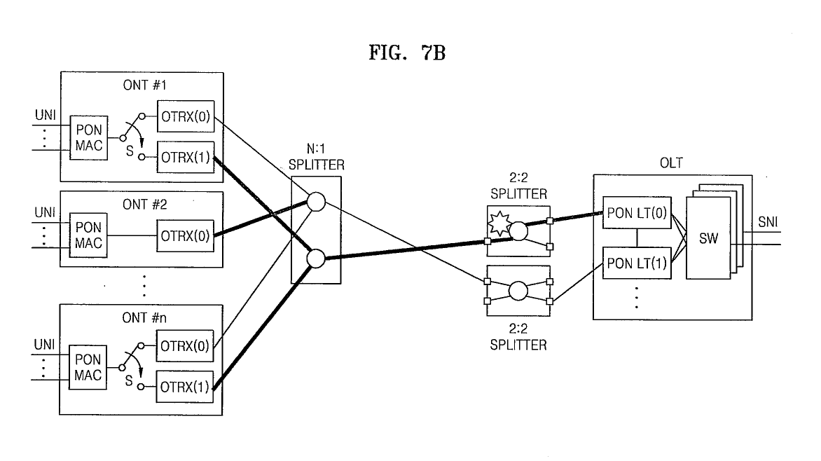

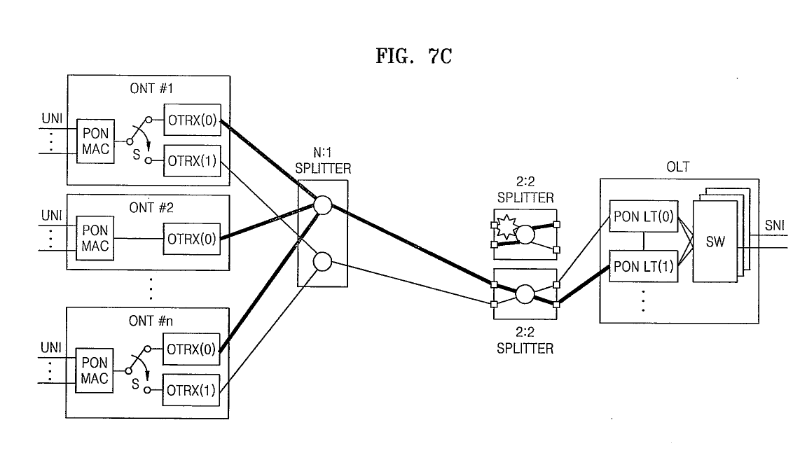

FIGS. 7A, 7B, and 7C are schematic diagrams for explaining a process of replacing a defective splitter according to an embodiment of the present invention.

FIG. 7A illustrates an example showing the position of an error of a 2:2 splitter and a protection switching state. In the present embodiment, since one 2:2 splitter is used in a PON link, if an error occurs in the splitter, the error should be removed without stopping the service.

An ordinary 2:2 splitter is made by connecting two optical cables in the middle, and is formed with one joining part, four optical cables, and an optical connector attached to the end of each of the optical cables. In most splitter errors, an error rarely occurs in the joining part itself, but instead errors usually occur in each optical cable and in each optical connector.

FIG. 7A shows a case where an error occurs in one cable of the 2:2 splitter. If an error occurs in an operational link on the ONT side in the 2:2 splitter as illustrated in FIG. 7A, protection switching is performed as indicated by a thick solid line according to a protection procedure. In this case, the cable in which the error occurs becomes a protection link which is not used for service, and the existing protection link becomes an operational link. In the two links on the OLT side, the current state is maintained so that one link is maintained as an operational link and the other is maintained as a protection link. If an error occurs in a splitter, the splitter in which the error occurs should be replaced by a normal splitter or repaired.

In order to replace the defective splitter, two protection links that are not currently being used for service are connected to a new splitter as illustrated in FIG. 7B. Then, the remaining two links are connected as illustrated in FIG. 7C. In this case, in FIG. 7B, an operational link is maintained. In FIG. 7C, if one link is removed, the existing path is cut off and the new splitter becomes an operational link. Then, if the remaining one cable is moved, the replacement of the defective splitter is completed.

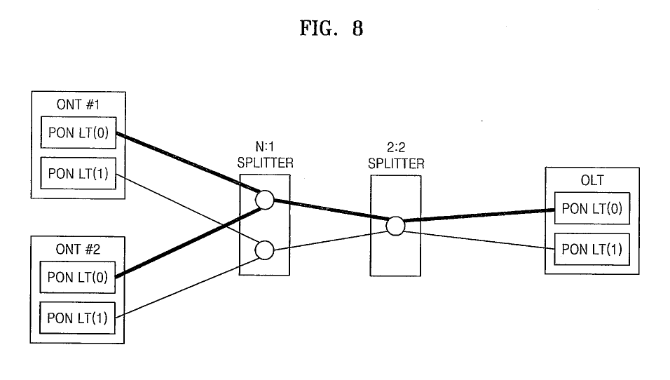

FIG. 8 is a simplified schematic diagram for explaining an apparatus for partial duplex protection switching in a PON according to an embodiment of the present invention.

The apparatus is essentially formed of one 2:2 splitter and one N:1 splitter. Each of a plurality of ONTs has two PON LTs and is connected to the N:1 splitter. In an OLT, two PON LTs are connected to the 2:2 splitter and connected to the N:1 splitter with two links, an operational link and a protection link.

The two PON LTs in the OLT can be connected to the 2:2 splitter with links of the same length. The two N:1 splitters are connected to the 2:2 splitter through links having different paths, respectively.

According to the present invention, the PON duplication method and apparatus formed of one 2:2 splitter, two N:1 splitters, and links connecting the splitters are provided. According to the apparatus and method, an economical effect can be provided in which two links, an operational link and a protection link, in the PON can provide a partial duplex function at a lower cost. Also, a protection switching time can be reduced by simplifying a restoration process so that when an error is detected an operational state is returned by performing protection switching.

This economical and effective PON duplication apparatus can be used in a fiber to the home (FTTH) service which requires a real-time high quality service, as in an Internet protocol TV (IPTV). Also, the present invention can be easily utilized in a broadband PON (B-PON), and an Ethernet PON (E-PON).

The present invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

While the present invention has been particularly shown and described with reference to exemplary embodiments thereof, it will be understood by those of ordinary skill in the art that various changes in form and details may be made therein without departing from the spirit and scope of the present invention as defined by the following claims. The preferred embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. An apparatus for duplex protection switching in a passive optical network (PON), in which a single optical line termination (OLT) and a plurality of optical network terminations (ONTs) are connected together in a multiple-access manner, comprising:
a 2:2 splitter connected to two PON line terminations (LTs) in the OLT; and
two N:1 splitters which are connected to the 2:2 splitter, and each of which is connected to two PON LTs in the ONT.

2. The apparatus of claim 1, wherein each of the PON LTs in the OLT is connected to the 2:2 splitter with a link having the same length.

3. The apparatus of claim 1, wherein the two N:1 splitters are connected to the 2:2 splitters through links having different paths, respectively.

4. The apparatus of claim 1, wherein in the OLT, the two PON LTs in the OLT are connected to a first link and a second link, respectively, which transmit and receive data between the OLT and the ONTs, and the OLT has a switch for transmitting data to and receiving data from one of the first link and the second link.

5. The apparatus of claim 1, wherein the ONT comprises:
a PON LT including an optical transmission and reception unit converting an electrical signal into an optical signal or an optical signal into an electrical signal, and transmitting and receiving an optical signal between the ONT and the N:1 splitter;
a PON connection unit transmitting and received data between the optical transmission and reception unit and a subscriber of the PON; and
a switch connecting the optical transmission and reception unit and the PON connection unit.

6. The apparatus of claim 1, wherein when the first link for transmitting and receiving data in the two links connecting the ONT and the N:1 splitter becomes a state of signal loss or frame loss, and thus data is transmitted and received through the second link, the ONT is connected to the N:1 splitter through a ranging process with respect to the length of the second link.

7. A method of managing two links of a PON in which a single OLT and a plurality of ONTs are connected together in a multiple-access manner, the method comprising:
measuring a round trip delay time between the OLT and the ONT, and ranging the distance in which the ONT transmits data to and receives data from the OLT;
a first link through which data is transmitted and received between the ONT and the OLT becomes a state of signal loss or frame loss, stopping transmission and reception of data in the first link, and performing a popup test of the OLT; and
if the OLT receives the popup test result message, transmitting and receiving data through a second link connected between the OLT and the ONT.

8. The method of claim 7, wherein in the stopping of the transmission and reception of data in the first link, and the performing of the popup test of the OLT, if an optical signal detection is failed through the first link, the transmission and reception of data in the first link is stopped and the popup test of the OLT is performed.

9. The method of claim 7, wherein in the transmitting and receiving of data through the second link connected between the OLT and the ONT, if the popup test result message is not received within a predetermined period of time, the transmission and reception of data between the ONT and the OLT is stopped.

10. A method of managing two links of a PON in which one OLT and a plurality of ONTs are connected together in a multiple-access manner, the method comprising:
the OLT searching for the ONT matched with the link of the OLT;
measuring a round trip delay time between the found ONT and the OLT, and ranging the distance in which the ONT transmits data to and receives data from the found ONT;
if a first link through which data is transmitted and received between the ONT and the OLT becomes a state of signal loss or frame loss, stopping transmission and reception of data in the first link, and performing a popup test of the OLT; and
if the OLT transmits the popup test result message to the ONT, transmitting and receiving data through a second link connected between the OLT and the ONT.

11. The method of claim 10, wherein in the stopping of the transmission and reception of data in the first link, and the performing of the popup test of the OLT, if an optical signal detection is failed through the first link, the transmission and reception of data in the first link is stopped and the popup test of the OLT is performed.

12. The method of claim 10, wherein in the transmitting and receiving of data through the second link connected between the OLT and the ONT, if the OLT transmits the popup test result to the ONT, the ONT transmits and receives data through the second link connected between the OLT and the ONT.

13. A method of managing two links of a PON in which a single OLT and a plurality of ONTs are connected together in a multiple-access manner, the method comprising:
setting one of the two links of a PON as a first link for transmitting and receiving data;
unless the first link is a state of signal loss or frame loss, transmitting and receiving data between the OLT and the ONT through the first link; and
if the first link is a state of signal loss or frame loss, setting the other link of the two links of a PON as a second link for transmitting and receiving data.
